(19) United States
(12) Patent Application Publication
(10) Pub. No.: US 2011/0291571 A1
(43) Pub. Date: Dec. 1, 2011

(54) INTELLIGENT ENERGY-SAVING LAMP

(75) Inventor: JIA-HUA FAN, HUANG JIANG TOWN (CN)

(73) Assignee: FONG KAI USA INC., CARROLLTON, TX (US)

(21) Appl. No.: 12/953,933

(22) Filed: Nov. 24, 2010

(30) Foreign Application Priority Data
May 18, 2010 (CN) 201020204351.1

(51) Int. Cl. H05B 37/02

(52) U.S. Cl. 315/152

(57) ABSTRACT

An intelligent energy-saving lamp includes a power source circuit, a main control circuit, a lighting circuit, and an infrared sensor circuit. The outgoing line of the power source circuit is connected to the incoming line of the main control circuit. The outgoing line of the main control circuit is connected to the incoming line of the lighting circuit. The infrared sensor circuit regulates the lighting circuit via the main control circuit. More specifically, the infrared sensor circuit senses the presence or absence of a person in the lighting area and instructs the main control circuit to regulate the lighting circuit accordingly, thereby saving energy. When people leave the lighting area, the lighting circuit enters the energy-saving mode and is prevented from working at maximum power. When people return, however, normal lighting resumes. Power consumption of the lamp in the energy-saving mode is only 20% of that for normal lighting.

### CROSS-REFERENCE TO RELATED APPLICATIONS

This application claims benefit of Chinese Application Serial No. 201020204351.1, filed May 18, 2010 entitled INTELLIGENT ENERGY-SAVING LAMP, the specification of which is incorporated herein by reference in its entirety.

### TECHNICAL FIELD

The present invention relates to the technical field of lighting equipment and, more particularly, to an intelligent energy-saving lamp capable of sensing the presence or absence of a person in the lighting area and adjusting the lighting intensity automatically and correspondingly.

### BACKGROUND

Energy-saving lamps such as LED lamps are increasingly popular and have been extensively used in our daily lives. However, most of the energy-saving lamps nowadays only feature low power consumption of the lamps themselves, but are not designed to save energy in response to variation in the environment. For instance, when there is no one in the lighting area and hence no need for lighting at full capacity, a conventional energy-saving lamp, once turned on, will still provide maximum lighting, which becomes a waste of energy. This is because the conventional energy-saving lamp is incapable of sensing the absence of people in the lighting area, let alone automatically dimming the light to further save electricity.

### SUMMARY

To solve the aforesaid problem of the conventional energy-saving lamp, namely failure to save energy according to actual needs, the present invention provides an energy-saving lamp whose luminosity is linearly variable and which is adjustable in response to the presence or absence of a person in the lighting area so as to save more energy. More specifically, when people leave the lighting area, the energy-saving lamp saves energy by reducing its luminosity automatically; and when people enter the lighting area again, the energy-saving lamp resumes maximum luminosity immediately for optimal lighting effect.

The present invention provides an intelligent energy-saving lamp which includes a power source circuit, a main control circuit, a lighting circuit, and an infrared sensor circuit. The outgoing line of the power source circuit is connected to the incoming line of the main control circuit. The outgoing line of the main control circuit is connected to the incoming line of the lighting circuit. The infrared sensor circuit regulates the lighting circuit by way of the main control circuit.

The live wire of the power source circuit is series-connected to a fuse cutout F1 and then connected to a capacitor C1 and an inductor L1. The other end of the capacitor C1 is connected to a null wire, an inductor L2, and a resistor R1. The other end of the inductor L1 is connected to pin 1 of a bridge rectifier D1.

Pin 2 of the bridge rectifier D1 is connected to the main control circuit or more specifically to capacitors C2, C3 and the anodes of diodes D2, D3. The other end of the capacitor C2 and the other end of the capacitor C3 are connected to a resistor R2 and an inductor L3. The other end of the diode D2 is series-connected to an inductor L4 while the other end of the inductor L4 is series-connected to the anode of a diode D6. The cathode of the diode D6 is connected to pin 2 of an inductive coupling element T1. The diode D3 is connected to resistors R3, R4; the anode of a polarized capacitor C12; a capacitor C4; and pin 1 of the inductive coupling element T1. The resistor R3 is series-connected to a resistor R14 and then connected to pin 3 of a chip IC1, wherein the model number of the chip IC1 is IW3620. The other end of the capacitor C4 is connected to the cathode of a diode D4 while the anode of the diode D4 is connected to pin 2 of the inductive coupling element T1. Pin 4 of the inductive coupling element T1 is series-connected to the anode of a diode D5 and then connected to the anode of a polarized capacitor C13; resistors R5, R6, R7; and a field-effect transistor Q4. The cathode of the polarized capacitor C13 is connected to the resistor R5 and then grounded. The other end of the resistor R6 is connected to a photoresistor CDS1 and the base of a triode Q1. The other end of the resistor R7 is connected to another end of the field-effect transistor Q4 and the collector of the triode Q1. The third end of the field-effect transistor Q4 is connected to the anode of the lighting circuit by way of pin 3 of a connection port CON2. The lighting circuit is composed of a plurality of LEDs which are series-connected before being parallel-connected. In the infrared sensor circuit, an infrared detection head U1 is connected to a resistor R23, a capacitor C15, and pin 2 of a chip IC2, wherein the model number of the chip IC2 is CSC9803F. Pin 4 of the chip IC2 is connected to the anode of a polarized capacitor C18 while the cathode of the polarized capacitor C18 is connected to the resistor R23 and then the other end of the capacitor C15 before being grounded. Pin 3 of the chip IC2 is connected to resistors R25, R30 and a capacitor C22. The other end of the resistor R25 and the other end of the capacitor C22 are connected to pin 1 of the chip IC2 and the cathode of a polarized capacitor C23. The anode of the polarized capacitor C23 is connected to a resistor R31, whose other end is connected to pin 14 of the chip IC2, a resistor R32, and a capacitor C25. The other end of the resistor R32 and the other end of the capacitor C25 are connected to pin 16 of the chip IC2. The other end of the resistor R30 is connected to the anode of a polarized capacitor C21. The cathode of the polarized capacitor C21 is grounded and is series-connected to a capacitor C26 and then connected to pin 16 of the chip IC2. Pin 9 of the chip IC2 is connected to the anode of a polarized capacitor C17 and a resistor R22. The cathode of the polarized capacitor C17 is connected to the other end of the resistor R22 and then grounded. Pin 6 of the chip IC2 is connected to a capacitor C16 and a resistor R24. The other end of the capacitor C16 is grounded while the other end of the resistor R24 is connected to pin 1 of a connection port CON1. Pin 8 of the chip IC2 is connected to a capacitor C19 and a resistor R26, wherein the other end of the capacitor C19 is grounded, and the other end of the resistor R26 is connected to pin 1 of the connection port CON1. A polarized capacitor C20 has an anode which is connected to pin 1 of the connection port CON1 and a cathode which is grounded. Pin 5 of the chip IC2 is connected to the cathode of the lighting circuit and pin 2 of the connection port CON1. Pin 11 of the chip IC2 is connected to a resistor R18 via pins 4 of the connection ports CON1, CON2. The other end of the resistor R18 is connected to the base of a triode Q2. The collector of the triode Q2 is series-connected to a resistor R17 and then connected to pin 1 of the connection port CON2. The emitter of the triode Q2 is connected to pin 1 of a photocoupler U4, wherein the model number of the photocoupler U4 is PC817. Pin 2 of the photocoupler U4 is grounded. Pin 3 of the photocoupler U4 is connected to pin 2 of an inductive coupling element T2; resistors R13, R19; and capacitors C7, C8, C9, C10, C11. The other end of the capacitor C7 and the other end of the resistor R13 are connected to pin 4 of the chip IC1. The capacitor C8 is connected to pin 3 of the chip IC1. The capacitor C9 is connected to pin 8 of the chip IC1 and a resistor R15, wherein the other end of the resistor R15 is connected to the other end of the capacitor C11 and the cathode of a diode D7. The anode of the diode D7 is connected to a resistor R16 and pin 1 of the inductive coupling element T2. Pin 4 of the photocoupler U4 is series-connected to a resistor R20 and then connected to the resistors R16, R19; the other end of the capacitor C10; and pin 2 of the chip IC1. Pin 5 of the chip IC1 is connected to a capacitor C6 and resistors R8, R9. The other end of the capacitor C6 is connected to a resistor R12 and pin 6 of the chip IC1. The other end of the resistor R8 and the other end of the resistor R9 are connected to a field-effect transistor Q5; the other end of the resistor R12; and a resistor R10. The other end of the resistor R10 is connected to a resistor R11 and another end of the field-effect transistor Q5. The other end of the resistor R11 is connected to pin 7 of the chip IC1. The third end of the field-effect transistor Q5 is connected to pin 2 of the inductive coupling element T1. Pin 4 of the inductive coupling element T2 is connected to the anode of a diode D9 and pin 3 of the inductive coupling element T1. Pin 3 of the inductive coupling element T2 is connected to pin 2 of the connection port CON2. The cathode of the diode D9 is connected to the anode of a polarized capacitor C14 and a resistor R21. The other end of the resistor R21 is connected to pin 1 of the connection port CON2 and the cathode of a voltage stabilizer ZD1. The cathode of the polarized capacitor C14 is grounded.

In the present invention, an ordinary lighting circuit is additionally connected with an infrared sensor circuit for sensing the presence or absence of a person in the lighting area and performing corresponding adjustment to save energy. Thus, when there is no one in the lighting area, the lighting circuit enters the energy-saving mode; and when people enter the lighting area, normal lighting resumes, wherein power consumption in the energy-saving mode is only 20% of that for normal lighting. As the lighting circuit is prevented from emitting light at full capacity after people leave the lighting area, electricity is saved to the benefit of environmental protection.

### BRIEF DESCRIPTION OF THE DRAWINGS

The structure as well as the objects, technical features, and advantageous effects of the present invention will be best understood by referring to the following detailed description of an illustrative embodiment in conjunction with the accompanying drawings, in which:

FIG. 1 is a block diagram of the present invention; and

FIG. 2 is a circuit diagram of the present invention.

### DETAILED DESCRIPTION

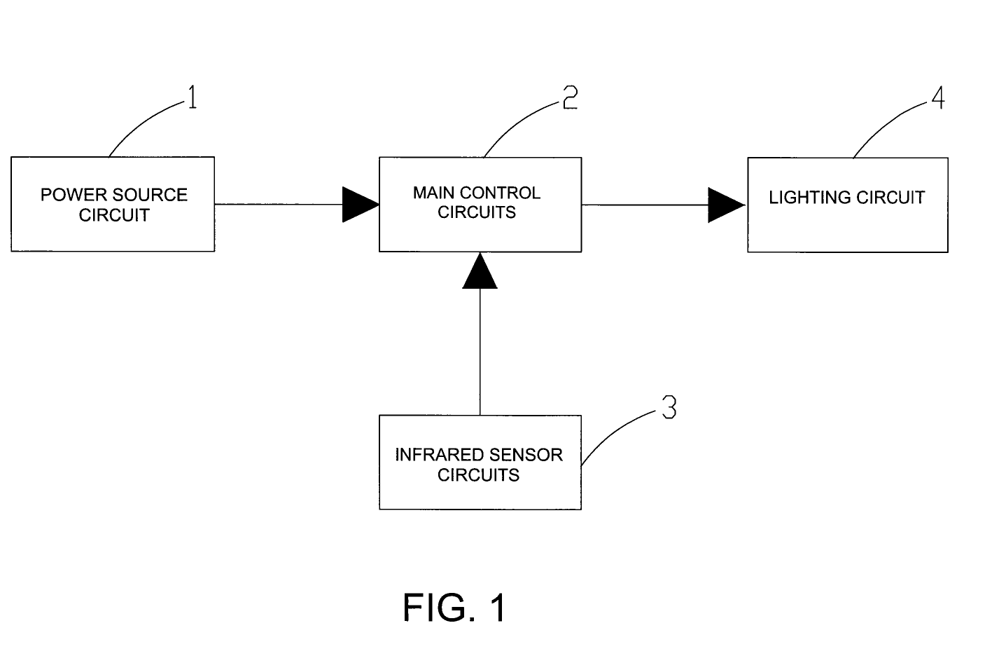

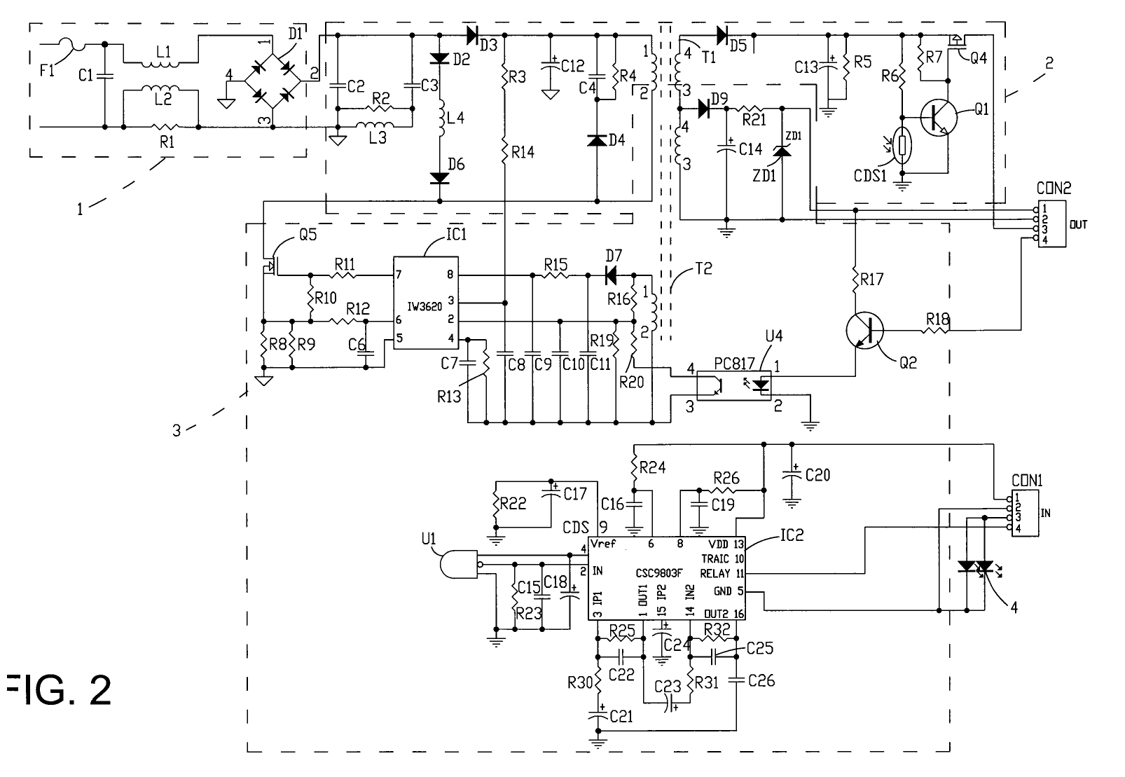

Referring to FIGS. 1 and 2, the present invention includes a power source circuit 1, a main control circuit 2, a lighting circuit 4, and an infrared sensor circuit 3. The outgoing line of the power source circuit 1 is connected to the incoming line of the main control circuit 2. The outgoing line of the main control circuit 2 is connected to the incoming line of the lighting circuit 4. The infrared sensor circuit 3 regulates the lighting circuit 4 via the main control circuit 2.

The power source circuit 1 mainly includes a fuse cutout F1 and a bridge rectifier D1.

The main control circuit 2 mainly includes an inductive coupling element T1, a photoresistor CDS1, a triode Q1, and a field-effect transistor Q4.

The lighting circuit 4 is composed of a plurality of LEDs which are series-connected and then parallel-connected.

The infrared sensor circuit 3 mainly includes an infrared detection head U1, a chip IC1 (IW3620), a triode Q2, a photocoupler U4 (PC817), an inductive coupling element T2, a field-effect transistor Q5, a voltage stabilizer ZD1, and a chip IC2 (CSC9803F).

The live wire of the power source circuit 1 is series-connected to the fuse cutout F1 and then connected to a capacitor C1 and an inductor L1. The other end of the capacitor C1 is connected to a null wire, an inductor L2, and a resistor R1. The other end of the inductor L1 is connected to pin 1 of the bridge rectifier D1.

Pin 2 of the bridge rectifier D1 is connected to the main control circuit 2 or more specifically to capacitors C2, C3 and the anodes of diodes D2, D3. The other end of the capacitor C2 and the other end of the capacitor C3 are connected to a resistor R2 and an inductor L3. The other end of the diode D2 is series-connected to an inductor L4 while the other end of the inductor L4 is series-connected to the anode of a diode D6. The cathode of the diode D6 is connected to pin 2 of the inductive coupling element T1. The diode D3 is connected to resistors R3, R4; the anode of a polarized capacitor C12; a capacitor C4; and pin 1 of the inductive coupling element T1. The resistor R3 is series-connected to a resistor R14 and then connected to pin 3 of the chip IC1, wherein the model number of the chip IC1 is IW3620. The other end of the capacitor C4 is connected to the cathode of a diode D4 while the anode of the diode D4 is connected to pin 2 of the inductive coupling element T1. Pin 4 of the inductive coupling element T1 is series-connected to the anode of a diode D5 and then connected to the anode of a polarized capacitor C13; resistors R5, R6, R7; and the field-effect transistor Q4. The cathode of the polarized capacitor C13 is connected to the resistor R5 and then grounded. The other end of the resistor R6 is connected to the photoresistor CDS1 and the base of the triode Q1. The other end of the resistor R7 is connected to another end of the field-effect transistor Q4 and the collector of the triode Q1. The third end of the field-effect transistor Q4 is connected to the anode of the lighting circuit 4 by way of pin 3 of a connection port CON2. The lighting circuit 4, as mentioned earlier, is composed of a plurality of LEDs which are series-connected before being parallel-connected.

In the infrared sensor circuit 3, the infrared detection head U1 is connected to a resistor R23, a capacitor C15, and pin 2 of the chip IC2, wherein the model number of the chip IC2 is CSC9803F. Pin 4 of the chip IC2 is connected to the anode of a polarized capacitor C18 while the cathode of the polarized capacitor C18 is connected to the resistor R23 and then the other end of the capacitor C15 before being grounded. Pin 3 of the chip IC2 is connected to resistors R25, R30 and a capacitor C22. The other end of the resistor R25 and the other end of the capacitor C22 are connected to pin 1 of the chip IC2 and the cathode of a polarized capacitor C23. The anode of the polarized capacitor C23 is connected to a resistor R31, whose other end is connected to pin 14 of the chip IC2, a resistor R32, and a capacitor C25. The other end of the resistor R32 and the other end of the capacitor C25 are connected to pin 16 of the chip IC2. The other end of the resistor R30 is connected to the anode of a polarized capacitor C21. The cathode of the polarized capacitor C21 is grounded and is series-connected to a capacitor C26 and then connected to pin 16 of the chip IC2. Pin 9 of the chip IC2 is connected to the anode of a polarized capacitor C17 and a resistor R22. The cathode of the polarized capacitor C17 is connected to the other end of the resistor R22 and then grounded. Pin 6 of the chip IC2 is connected to a capacitor C16 and a resistor R24. The other end of the capacitor C16 is grounded while the other end of the resistor R24 is connected to pin 1 of a connection port CON1. Pin 8 of the chip IC2 is connected to a capacitor C19 and a resistor R26, wherein the other end of the capacitor C19 is grounded, and the other end of the resistor R26 is connected to pin 1 of the connection port CON1. A polarized capacitor C20 has an anode which is connected to pin 1 of the connection port CON1 and a cathode which is grounded. Pin 5 of the chip IC2 is connected to the cathode of the lighting circuit 4 and pin 2 of the connection port CON1. Pin 11 of the chip IC2 is connected to a resistor R18 via pins 4 of the connection ports CON1, CON2. The other end of the resistor R18 is connected to the base of the triode Q2. The collector of the triode Q2 is series-connected to a resistor R17 and then connected to pin 1 of the connection port CON2. The emitter of the triode Q2 is connected to pin 1 of the photocoupler U4, wherein the model number of the photocoupler U4 is PC817. Pin 2 of the photocoupler U4 is grounded. Pin 3 of the photocoupler U4 is connected to pin 2 of the inductive coupling element T2; resistors R13, R19; and capacitors C7, C8, C9, C10, C11. The other end of the capacitor C7 and the other end of the resistor R13 are connected to pin 4 of the chip IC1. The capacitor C8 is connected to pin 3 of the chip IC1. The capacitor C9 is connected to pin 8 of the chip IC1 and a resistor R15, wherein the other end of the resistor R15 is connected to the other end of the capacitor C11 and the cathode of a diode D7. The anode of the diode D7 is connected to a resistor R16 and pin 1 of the inductive coupling element T2. Pin 4 of the photocoupler U4 is series-connected to a resistor R20 and then connected to the resistors R16, R19; the other end of the capacitor C10; and pin 2 of the chip IC1. Pin 5 of the chip IC1 is connected to a capacitor C6 and resistors R8, R9. The other end of the capacitor C6 is connected to a resistor R12 and pin 6 of the chip IC1. The other end of the resistor R8 and the other end of the resistor R9 are connected to the field-effect transistor Q5; the other end of the resistor R12; and a resistor R10. The other end of the resistor R10 is connected to a resistor R11 and another end of the field-effect transistor Q5. The other end of the resistor R11 is connected to pin 7 of the chip IC1. The third end of the field-effect transistor Q5 is connected to pin 2 of the inductive coupling element T1. Pin 4 of the inductive coupling element T2 is connected to the anode of a diode D9 and pin 3 of the inductive coupling element T1. Pin 3 of the inductive coupling element T2 is connected to pin 2 of the connection port CON2. The cathode of the diode D9 is connected to the anode of a polarized capacitor C14 and a resistor R21. The other end of the resistor R21 is connected to pin 1 of the connection port CON2 and the cathode of the voltage stabilizer ZD1. The cathode of the polarized capacitor C14 is grounded.

The working principle of the present invention is stated as follows. When the illuminance of the photoresistor CDS1 is greater than 10LX±5LX, as caused by the ambient lighting during the day, the resistance of the photoresistor CDS1 is reduced, thereby cutting off the field-effect transistor Q4 and bringing the lighting circuit 4 into the standby state, in which the lighting circuit 4 is powered but does not work. However, when the illuminance of the photoresistor CDS1 becomes smaller than 10LX±5LX, as produced by the ambient lighting at night, the resistance of the photoresistor CDS1 is increased. As a result, both the triode Q1 and the field-effect transistor Q4 are turned on, and the luminosity of lighting circuit 4 increases linearly. When the illuminance resulting from ambient lighting drops below 1LX, and the infrared detection head U1 senses no human presence in the lighting area, pin 11 of the chip IC2 outputs a low-level signal to the triode Q2 such that the photocoupler U4 is cut off. Because of that, the feedback signal is increased, thereby lowering the voltage output by pin 2 of the chip IC2 and the current supplied to the lighting circuit 4. Hence, the perceived brightness, or the luminous flux, of the LEDs is reduced, and the lighting circuit 4 enters the energy-saving mode to save energy. When the infrared detection head U1 senses the presence of a person, the sensing signal is amplified by the chip IC2 to produce a high-level signal, which is output to the triode Q2 via pin 11 of the chip IC2. Consequently, the photocoupler U4 is turned on to reduce the feedback signal and raise the output voltage from pin 2 of the chip IC2, thereby increasing the current to the lighting circuit 4 and the perceived brightness, or the luminous flux, of the LEDs. Thus, the lighting circuit 4 resumes normal lighting, which, however, lasts one minute only, for the infrared detection head U1 detects the presence or absence of a person in the lighting area at a one-minute interval. In other words, the lighting circuit 4 will be automatically switched to the energy-saving mode again not more than one minute after the person leaves the range of surveillance.

The embodiment described above serves only to demonstrate the best mode of carrying out the present invention but not to limit the scope of the present invention. A person of ordinary skill in the art who has reviewed the technical contents disclosed herein may alter or modify the foregoing embodiment without departing from the spirit of the present invention. Therefore, the scope of the present invention is defined only by the appended claims.

What is claimed is:

1. An intelligent energy-saving lamp, comprising:
A power source circuit;
A main control circuit having an incoming line connected to an outgoing line of the power source circuit;
A lighting circuit having an incoming line connected to an outgoing line of the main control circuit; and
An infrared sensor circuit configured to regulate the lighting circuit via the main control circuit.

2. The intelligent energy-saving lamp of claim 1, wherein the power source circuit essentially comprises a fuse cutout and a bridge rectifier.

3. The intelligent energy-saving lamp of claim 1, wherein the main control circuit essentially comprises an inductive coupling element, a photoresistor, a triode, and a field-effect transistor.

4. The intelligent energy-saving lamp of claim 1, wherein the lighting circuit is composed of a plurality of LEDs which are series-connected and then parallel-connected.

5. The intelligent energy-saving lamp of claim 1, wherein the infrared sensor circuit essentially comprises an infrared detection head, a chip, a triode, a photocoupler, an inductive coupling element, a field-effect transistor, a voltage stabilizer, and another chip.
